(19) United States
(12) Patent Application Publication
(10) Pub. No.: US 2025/0298956 A1
(43) Pub. Date: Sep. 25, 2025

(54) LAYOUT DESIGN METHOD AND METHOD OF MANUFACTURING A SEMICONDUCTOR DEVICE

(71) Applicant: Samsung Electronics Co., Ltd., Suwon-si (KR)

(72) Inventors: Mihye Kim, Suwon-si (KR); Jihun Kim, Suwon-si (KR)

(21) Appl. No.: 19/035,291

(22) Filed: Jan. 23, 2025

(30) Foreign Application Priority Data
Mar. 19, 2024 (KR) 10-2024-0037916

(51) Int. Cl. G06F 30/398; G03F 1/36

(52) U.S. Cl. CPC G06F 30/398; G03F 1/36

(57) ABSTRACT

Provided is a layout design method including generating a first layout of an integrated circuit, performing first simulation on the first layout, generating a second layout considering the first simulation and a process margin, extracting a first calculated value based on the first layout and a second calculated value based on the second layout, and generating a final layout that satisfies a target value based on the first calculated value and the second calculated value, wherein the first calculated value and the second calculated value may be values calculated by circuit structures corresponding to the first layout and the second layout, respectively.

### CROSS-REFERENCE TO RELATED APPLICATION

This application is based on and claims priority under 35 U.S.C. § 119 to Korean Patent Application No. 10-2024-0037916, filed on Mar. 19, 2024, in the Korean Intellectual Property Office, the disclosure of which is incorporated by reference herein in its entirety.

### BACKGROUND

The inventive concept relates to a layout design method and a method of manufacturing a semiconductor device, and more particularly, to a layout design method considering a process margin or optical proximity correction results and a method of manufacturing a semiconductor device including the layout design method.

Semiconductor devices provide various circuits necessary for an operation in the form of modules, and these modules are units with independent functions as a portion of a system. To manufacture semiconductor devices, a designer first designs a layout of circuit patterns according to the characteristics of a semiconductor chip based on a design rule.

After the layout is designed, optical proximity correction (OPC) may be performed. In this case, before OPC is performed, an operation of preparing a target of OPC by considering the process margin may be performed. However, when a process margin is considered after layout design is completed, there is a problem in that the already designed layout is changed again.

### SUMMARY

The inventive concept provides a layout design method considering a process margin.

According to another aspect of the inventive concept, there is provided a layout design method.

The method may include generating a first layout of an integrated circuit, performing first simulation on the first layout, generating a second layout considering the first simulation and a process margin, extracting a first calculated value based on the first layout and a second calculated value based on the second layout, and generating a final layout that satisfies a target value based on the first calculated value and the second calculated value, wherein the first calculated value and the second calculated value may be values calculated by circuit structures corresponding to the first layout and the second layout, respectively.

According to another aspect of the inventive concept, there is provided a layout design method.

The method may include generating a first layout of an integrated circuit, performing first simulation on the first layout, generating a second layout considering the first simulation and a process margin, extracting a first calculated value based on the first layout and a second calculated value based on the second layout, and generating a final layout that satisfies a target value, based on the first calculated value and the second calculated value, wherein the generating of the final layout may include performing optical proximity correction and generating a contour based on the optical proximity correction to modify a layout, and the first calculated value and the second calculated value may be values calculated by circuit structures corresponding to the first layout and the second layout, respectively.

According to another aspect of the inventive concept, there is provided a method of manufacturing a semiconductor device.

The method may include performing design of a semiconductor device, and manufacturing the semiconductor device based on the design, wherein the performing of the design of the semiconductor device may include performing high level design, and performing layout design based on the high level design, the manufacturing of the semiconductor device may include performing optical proximity correction based on the designed layout, and manufacturing a mask based on a result of the optical proximity correction, the performing of the layout design may include generating a first layout of an integrated circuit, performing simulation based on the first layout, generating a second layout considering the simulation and a process margin, and extracting calculated values based on the first layout and the second layout, respectively, and modifying the second layout to satisfy a target value based on the calculated value, and the calculated value may be a value calculated by circuit structures corresponding to the first layout and the second layout, respectively.

### BRIEF DESCRIPTION OF THE DRAWINGS

Embodiments will be more clearly understood from the following detailed description taken in conjunction with the accompanying drawings in which:

FIG. 1 is a block diagram showing a computer system for designing a semiconductor device according to an example embodiment;

FIG. 2 is a flowchart showing a method of designing and manufacturing a semiconductor device according to an example embodiment;

FIG. 3 is a flowchart showing a layout design method according to an example embodiment;

FIG. 4 is a flowchart showing a layout design method according to an example embodiment;

FIG. 5 is a diagram for explaining a method of obtaining a target value according to an example embodiment;

FIGS. 6A to 6C illustrate layouts generated according to an example embodiment;

FIG. 7 is a flowchart showing a layout design method according to an example embodiment;

FIG. 8 is a flowchart showing a layout design method according to an example embodiment;

FIGS. 9A to 9F illustrate layouts generated according to an example embodiment;

FIG. 10 is a flowchart showing a layout design method generated according to an example embodiment;

FIG. 11 is a block diagram showing a memory system to which a layout design method is applied according to an example embodiment; and

FIG. 12 is a flowchart of a method of manufacturing a semiconductor device using a photomask optimized according to example embodiments.

### DETAILED DESCRIPTION OF THE EMBODIMENTS

Hereinafter, various embodiments are described with reference to the attached drawings. Like reference characters refer to like elements throughout.

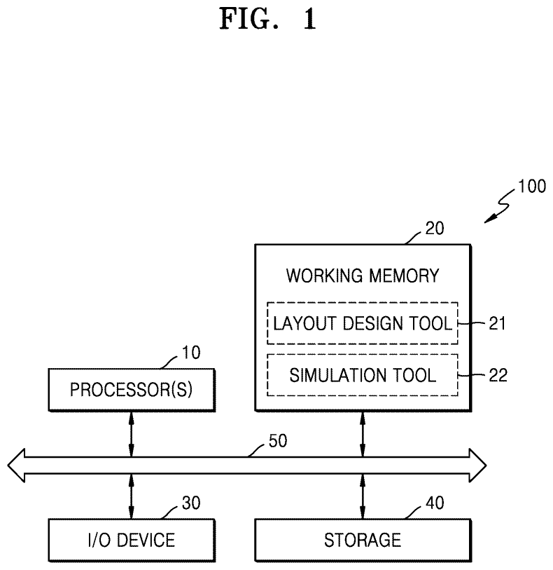

FIG. 1 is a block diagram showing a computer system for designing a semiconductor device according to an example embodiment.

Referring to FIG. 1, a computer system (or layout design system) 100 may include at least one processor 10, a working memory 20, an input/output device 30, and a storage device 40. The at least one processor 10, the working memory 20, the input/output device 30, and the storage device 40 may be connected to each other through a system interconnector 50 (e.g., bus). Here, the computer system 100 may be provided as a dedicated device for designing the layout according to the inventive concept. The computer system 100 may be configured to execute various designs and verification simulation programs.

The processor 10 may execute software (e.g., application program, operating system (OS), and device driver) to be executed on computer system 100. The processor 10 may execute an OS (not shown) loaded into the working memory 20. The processor 10 may execute various application programs to be executed based on the OS. For example, the processor 10 may execute a layout design tool 21 loaded into the working memory 20.

The working memory 20 may include a volatile memory such as static random access memory (SRAM) or dynamic random access memory (DRAM). However, the working memory 20 is not limited thereto and may include a non-volatile memory such as phase-change RAM (PRAM), magnetic random access memory (MRAM), resistance RAM (ReRAM), ferroelectric RAM (FRAM), and flash memory.

An OS or application programs may be loaded into the working memory 20. When the computer system 100 boots, an OS image (not shown) stored in the storage device 40 may be loaded into the working memory 20 according to a boot sequence. All input/output operations of the computer system 100 may be supported by the OS. Likewise, application programs may be loaded into the working memory 20 to provide a service by a user or a basic service. In particular, the layout design tool 21 for layout design according to an embodiment may also be loaded into the working memory 20 from the storage device 40.

The layout design tool 21 may have a function to change the shape and position of layout patterns.

A simulation tool 22 that performs various simulations on the designed layout data may be further loaded into the working memory 20. According to one example, the simulation tool 22 may perform design rule check (DRC), electrical rule check (ERC), layout vs schematic (LVS), optical proximity correction (OPC), and the like on the changed layout patterns. The simulation tool 22 may perform simulation on the layout patterns generated by the layout design tool 21 and calculate a capacitance value corresponding to the layout. This will be described in detail below.

The input/output device 30 controls user input and output from user interface devices. For example, the input/output device 30 may include a keyboard or a monitor to receive information from the designer. The designer may receive information about semiconductor regions or data paths that require adjusted operating characteristics by using the input/output device 30. A processing process and processing result of the simulation tool 22 may be displayed through the input/output device 30.

The storage device 40 is provided as a storage medium of the computer system 100. The storage device 40 may store application programs, operating system images, and various data. For example, the storage device 40 may be provided as solid state drive (SSD), embedded multimedia card (eMMC), or hard disk drive (HDD). The storage device 40 may include NAND flash memory. However, the inventive concept is not limited thereto, and the storage device 40 may include a non-volatile memory such as PRAM, MRAM, ReRAM, or FRAM.

The system interconnector 50 may be a system bus for providing a network within the computer system 100. Through the system interconnector 50, the processor 10, the working memory 20, the input/output device 30, and the storage device 40 may be electrically connected to each other and may exchange data with each other. However, the configuration of the system interconnector 50 is not limited to the above description, and may further include mediation devices for efficient management.

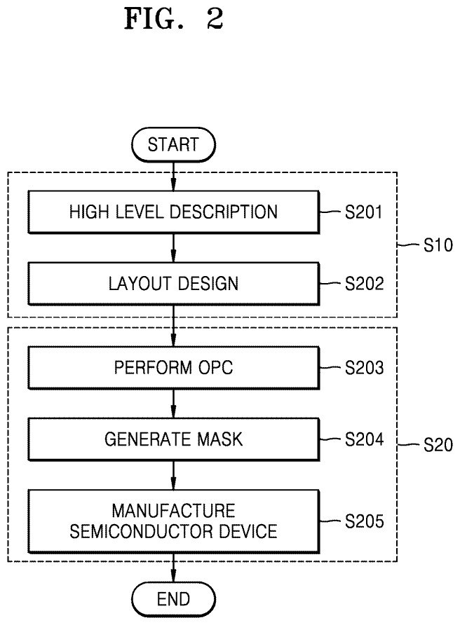

FIG. 2 is a flowchart showing a method of designing and manufacturing a semiconductor device according to an example embodiment.

High level design of a semiconductor integrated circuit may be performed using the computer system 100 of FIG. 1 (S201). The high level design may mean describing an integrated circuit to be designed in a higher-level computer language. For example, a higher-level language such as the C language may be used. Circuits designed by high level design may be expressed in more detail by register transfer level (RTL) coding or simulation. Code generated by RTL coding may be converted into Netlist to synthesize an entire semiconductor device. The synthesized schematic circuit may be verified by the simulation tool 22, and an adjustment process may be involved according to the verification result.

Layout design to implement a logically completed semiconductor integrated circuit on a silicon substrate may be performed (S202). For example, layout design may be performed with reference to a schematic circuit synthesized in high level design or the corresponding Netlist. Layout design may include a routing procedure for placing and connecting various standard cells provided in a cell library according to a prescribed design rule.

The standard cell may refer to a configuration of a logic element (e.g., inverter or flip-flop) that performs a certain function. For example, the standard cell may include a plurality of transistors for configuring a logic element, and wiring connecting the plurality of transistors.

The cell library for layout design may also include information on the operation, speed, and power consumption of the standard cell. A cell library for expressing a circuit at a certain gate level as a layout is defined in most layout design tools. The layout may be a procedure for defining a shape or size of a pattern for configuring transistors and metal wires to be actually formed on a silicon substrate. For example, to actually form an inverter circuit on a silicon substrate, layout patterns such as PMOS, NMOS, N-WELL, a gate electrode, and metal wirings to be disposed thereon may be appropriately arranged.

To this end, a suitable inverter may be searched for and selected from among inverters already defined in the cell library. Routing may be performed on selected and arranged standard cells. Most of these series of processes may be performed automatically or manually by a layout design tool.

After routing, the layout may be verified to check whether there are any portions against a design rule. Examples of a verification operation include design rule check (DRC) for verifying whether the layout is properly designed in accordance with the design rule, electrical rule check (ERC) for verifying whether the layout is properly designed without being internally electrically disconnected, and layout vs schematic (LVS) for verifying whether the layout matches a gate-level Netlist.

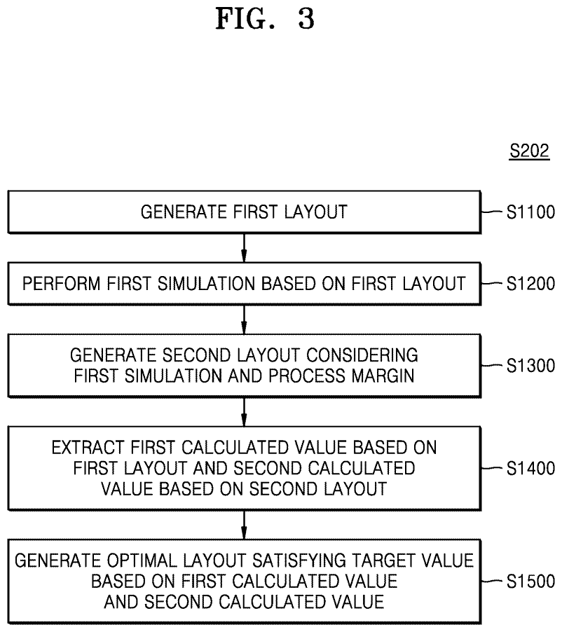

According to the inventive concept, in a layout design operation S202, a layout with increased accuracy may be output by performing layout design in consideration of a process margin. This will be explained in more detail with reference to FIG. 3 below.

Once the layout design is completed, optical proximity correction (OPC) may be performed (S203). Layout patterns obtained through layout design may be implemented on a silicon substrate by using a photolithography process. In this case, OPC may be a technology for correcting a distortion phenomenon that may occur in the photolithography process. In other words, the distortion phenomenon such as refraction or process effects that occur due to the characteristics of light during exposure using the laid out pattern may be corrected through OPC. While performing OPC, the shape and position of the designed layout patterns may be slightly changed. Therefore, a pattern such as an initial layout may be formed by applying an error due to OPC, changing the layout, producing a mask based on the changed layout, and performing a photolithography process. According to one example, OPC may be applied to the entire layout, i.e., a full chip.

Photomasks may be produced based on the layout changed by OPC (S204). In general, photomasks may be manufactured by depicting layout patterns by using a chrome thin film applied on a glass substrate. According to one example, a mask may be produced using a layout to which OPC is applied, for example, a graphic design system (GDS) to which OPC is applied.

A semiconductor device may be manufactured using the produced photomasks (S205). In a manufacturing process of a semiconductor device using photomasks, various types of exposure and etching processes may be repeatedly performed. Through these processes, the shapes of patterns configured during layout design may be sequentially formed on a silicon substrate.

Operations S201 and S202 may be design operations for a semiconductor integrated circuit to be manufactured (S10). Layout design for a semiconductor integrated circuit according to an example may include a semiconductor integrated circuit design method of FIG. 3. Operations S203, S204, and S205 may be operations for manufacturing a semiconductor integrated circuit based on the completed layout (S20). Referring to FIG. 2, operation S10 may correspond to a design operation, and operation S20 may correspond to a process operation. The layout design method according to the inventive concept relates to a layout design method performed in the design operation provided in operation S10.

FIG. 3 is a flowchart showing a layout design method according to an example embodiment.

The flowchart shown in FIG. 3 may be included in operation S202 of FIG. 2. For example, a semiconductor integrated circuit may be manufactured based on the layout lastly generated according to FIG. 3. Layout design methods according to the inventive concept may be processed by the layout design tool 21 and the simulation tool 22 of FIG. 1.

Referring to operation S1100, a first layout may be generated. According to one example, the first layout may be an initial layout corresponding to a pixel circuit. According to one example, the first layout may include a metal pattern. According to one example, the layout may be a data format such as open artwork system interchange standard (OASIS) or graphic data system II (GDS2). According to one example, the first layout may be a layout of an integrated circuit. According to one example, the first layout may be a layout generated based on elements arranged in the integrated circuit.

Referring to operation S1200, a first simulation may be performed based on the first layout. According to one example, a process of determining whether the first layout satisfies a plurality of design rules may be defined as a first simulation. According to the inventive concept, performing a simulation based on a layout may mean determining whether the corresponding layout satisfies a plurality of design rules according to various determination conditions. According to the inventive concept, DRC, LVS, ERC, and the like are disclosed as examples of simulation performance, but detailed methods of simulation performance may not be limited thereto.

Referring back to operation S1200, the first layout that satisfies the design rule may be determined by performing the first simulation based on the first layout. According to one example, when the generated first layout does not satisfy the design rule, the first layout may be modified to satisfy the design rule.

Referring to operation S1300, a second layout may be generated considering the first simulation and the process margin. According to one example, the second layout may be a layout generated in consideration with both the first simulation result and process margin information. According to the inventive concept, the second layout considering the first simulation and the process margin may mean a layout in which element arrangement and the like are modified to satisfy the process margin while satisfying a plurality of design rules. According to one example, the process margin may be a preset value. Alternatively, the process margin may be a value to be set by the user. According to one example, the second layout considering the process margin may be a layout formed in consideration of a table driven layer operation (TDLO). This will be described below.

Referring to operation S1400, a first calculated value based on the first layout and a second calculated value based on the second layout may be extracted. According to one example, the first calculated value may be a capacitance value in a circuit provided in the first layout. According to one example, the first calculated value may be capacitance at a conversion gain of a pixel circuit provided in the first layout. According to one example, the second calculated value may be a capacitance value in a circuit provided in the second layout. According to one example, the second calculated value may be capacitance at a conversion gain of a pixel circuit provided in the second layout. In the inventive concept, the first calculated value and the second calculated value are assumed to be capacitance values, but in the layout design according to the inventive concept, the calculated value for generating an optimal layout may be a value other than the capacitance value. According to one example, the first calculated value and the second calculated value may be values calculated by circuit structures corresponding to the first layout and the second layout, respectively. According to one example, result values that vary depending on layout arrangement may be set as calculated values. According to one example, the operation of extracting the first calculated value based on the first layout and the second calculated value based on the second layout may be processed by a simulation tool. According to one example, the simulation tool may extract the capacitance value of the conversion gain in the pixel circuit based on circuit information provided in the first layout and the second layout, that is, the arrangement position or resistance value of the metal pattern. According to one example, a simulation may be performed to extract the capacitance value based on GDS.

Referring to operation S1500, an optimal layout that satisfies a target value may be generated based on the first calculated value and the second calculated value. According to one example, the first calculated value and the second calculated value may be compared with the target value to determine whether the first calculated value and the second calculated value are contained in an error range of the target value. An optimal layout may be generated to have a calculated value that satisfies the error range of the target value and output as a final layout.

According to a comparative example, in a previous operation of OPC after the final layout is generated, metal arrangement provided in the layout is changed while operations to maximize the process margin are performed, resulting in a problem in which a layout to which the previously set values are applied is changed. In the inventive concept, it may be efficient that the final layout considering the process margin is generated by generating a layout in consideration of the process margin and repeating the generated layout to satisfy preset conditions.

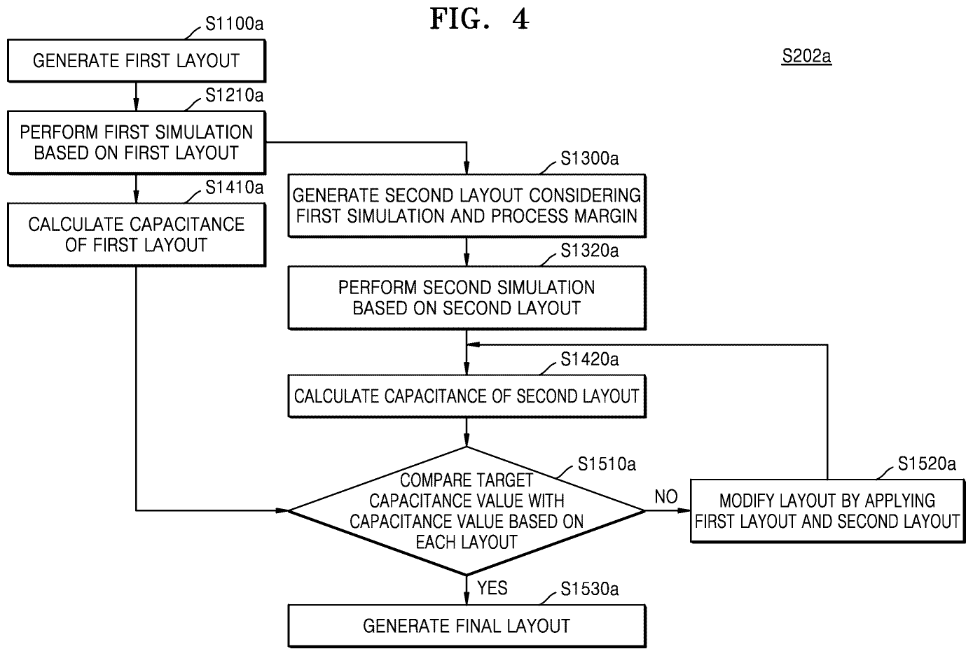

FIG. 4 is a flowchart showing a layout design method according to an example embodiment.

Operation S202a shown in FIG. 4 may be an example of operation S202 in FIG. 3. In describing each operation of FIG. 4, repetition of the description of FIG. 3 will be omitted.

In operation S1100a, the first layout may be generated. Operation S1100a of FIG. 4 may correspond to operation S1100 of FIG. 3. For example, operation S1100a of FIG. 4 may be the same as operation S1100 of FIG. 3.

In operation S1210a, the first simulation may be performed based on the first layout. Operation S1210a of FIG. 4 may correspond to operation S1200 of FIG. 3. For example, operation S1210a of FIG. 4 may be the same as operation S1200 of FIG. 3.

In operation S1300a, the second layout may be generated considering the first simulation and the process margin. Operation S1300a of FIG. 4 may correspond to operation S1300 of FIG. 3. The second layout considering the process margin may be a second layout formed in consideration of a table driven layer operation (TDLO). The TDLO may refer to an operation of generating a target for OPC. According to one example, the TDLO may be an operation of generating an OPC target layer to maximize the process margin. In the operation of generating the OPC target layer, the layout may be changed significantly when considering the process margin, and thus this operation may be performed in advance in the layout design operation.

According to one example, the TDLO may be a pre-OPC operation. In the TDLO, for example, a target pattern (or OPC target pattern) may be generated based on the original pattern. For example, in consideration of factors such as etch skew, the target pattern may be generated through a process such as pushing or pulling edges of the original pattern. For example, an original pattern with a size of 5×50 may be changed to a target pattern with a size of 5×70 in consideration of etch skew. To accurately implement the original pattern, a dummy may be added to an empty area (i.e., generation of a dummy target pattern). A layer may be defined by calculating the original patterns and the generated target patterns (for example, adding, subtracting, or finding a complement).

According to one example, the second layout may be generated by considering the TDLO according to the above example, based on the first layout. The second layout is a layout generated in consideration of both the first simulation result and the process margin, and thus the second layout may be a layout that ensures a process margin value while satisfying the design rule.

In operation S1320a, the second simulation may be performed based on the second layout. According to one example, operation S1320a may be omitted. The second layout is generated considering the first simulation, and thus may already satisfy the design rule. According to one example, the second simulation based on the second layout may be performed for confirmation.

In operation S1410a, capacitance of the first layout may be calculated. In operation S1420a, capacitance of the second layout may be calculated. Operations S1410a and S1420b may correspond to operation S1400. For example, operations S1410a and S1420a of FIG. 4 may correspond to operation S1400 of FIG. 3. In the inventive concept, the capacitance value in each layout is explained as a calculated value, but it has been described above that the value to be extracted from each layout is not limited to the capacitance value.

In operation S1510a, a target capacitance value and a capacitance value according to each layout may be compared with each other. According to one example, the target capacitance value, the capacitance value according to the first layout, and the capacitance value according to the second layout may be compared with each other. As the comparison result, when the capacitance value according to the first layout or the capacitance value according to the second layout is within the error range of the target capacitance value (Yes), the second layout to which the process margin is applied may be generated as the final layout (S1530a). As the comparison result, when the capacitance value according to the first layout or the capacitance value according to the second layout is not within the error range of the target capacitance value (No), in operation S1520a, the layout may be modified by applying the first layout and the second layout. According to one example, in operation S1520a, based on a relationship between the capacitance value according to the first layout or the capacitance value according to the second layout, data therefor may be ensured. Based on such data, the layout may be modified.

When the layout is modified, the capacitance of the layout may be recalculated based thereon (S1420a). By comparing the calculated capacitance value with the target capacitance value, the layout may be modified until satisfactory and the final layout may be generated.

In the example of FIG. 4, the capacitance is calculated immediately when the modified layout is generated (S1520a), but the capacitance may be calculated after simulation is performed based on the modified layout.

The layout design method according to the inventive concept may improve the consistency of the conversion gain by extracting the capacitance by performing a simulation to which the process margin is applied in the design operation. The layout design method according to the inventive concept may be applied to the operation of generating the layout of a circuit for controlling conversion gain by using a metal capacitor.

In the layout design method according to the inventive concept, the operation of modifying the layout in consideration of the process margin and the operation of extracting capacitance for the target value of the conversion gain may be combined by performing the operation of generating the layout considering the process margin in the operation before the capacitance is extracted, the layout may be modified and the capacitance may be checked until the target value is obtained.

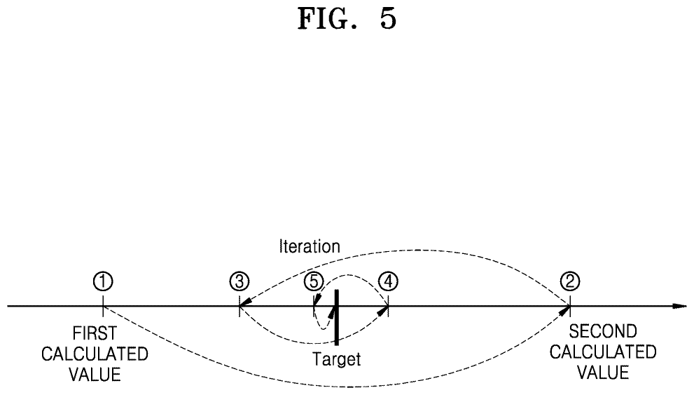

FIG. 5 is a diagram for explaining a method of obtaining a target value according to an example embodiment.

The first calculated value in FIG. 5 may be a capacitance value based on the first layout calculated in operation S1410a of FIG. 4. The second calculated value in FIG. 5 may be a capacitance value based on the second layout calculated in operation S1420a of FIG. 4. A target value Target in FIG. 5 may be a capacitance value to be obtained through the final layout.

Referring to FIG. 5, the target value may be located between the first calculated value and the second calculated value. To obtain a corresponding calculated value within the error range of the target value, an appropriate layout may be generated by repeatedly performing an iteration process.

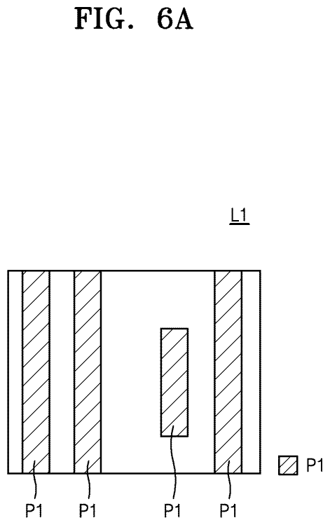

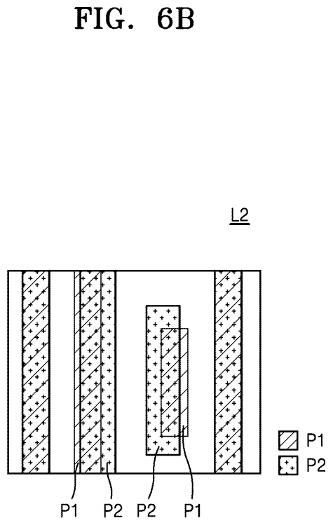

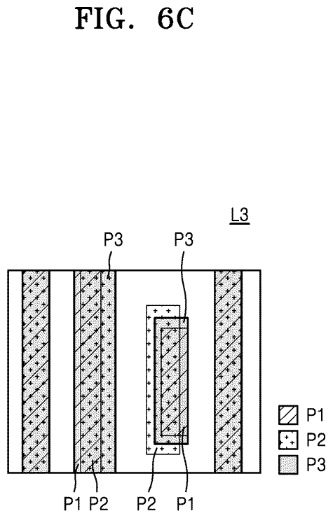

FIGS. 6A to 6C illustrate layouts generated according to an example embodiment.

Referring to FIGS. 6A to 6C, layouts L1, L2, and L3 may include metal patterns P1, P2, and P3, respectively. According to one example, the metal patterns P1, P2, and P3 that are respectively provided in the layouts L1, L2, and L3 shown in FIGS. 6A to 6C may be portions of metal patterns provided in respective layouts.

The layout L1 according to FIG. 6A may include the first metal pattern P1. The layout L2 according to FIG. 6B may include the second metal pattern P2. The first metal pattern P1 shown in FIG. 6B is shown to easily explain a difference from the second metal pattern P2, and may not be provided in the layout L2. For example, in the layout L2, only the second metal pattern P2 may be provided. The layout L3 according to FIG. 6C may include the third metal pattern P3. The first metal pattern P1 and the second metal pattern P2 shown in FIG. 6C is shown to easily explain a difference from the third metal pattern P3, and may not be provided in the layout L3. For example, in the layout L3, only the third metal pattern P3 may be provided.

According to one example, the layout L1 shown in FIG. 6A may be the first layout corresponding to operation S1100a of FIG. 4. The layout L2 shown in FIG. 6B may be the second layout corresponding to operation S1300a of FIG. 4. The layout L3 shown in FIG. 6C may be a modified layout corresponding to operation S1520a of FIG. 4.

The layout L1 shown in FIG. 6A may include the first metal pattern P1 and may be a layout that is initially designed and generated. The layout L2 shown in FIG. 6B may include the second metal pattern P2 and may be a layout generated in consideration of the process margin. The layout L3 shown in FIG. 6B may be a layout generated by considering both the process margin and the simulation result for the layout shown in FIG. 6A. The second metal pattern P2 provided in the layout L2 shown in FIG. 6B is generated with its size and position adjusted differently compared to the first metal pattern P1. The layout L3 shown in FIG. 6C may be a layout modified in consideration of both the layout shown in FIG. 6A and the layout shown in FIG. 6B. The third metal pattern P3 provided in the layout L3 shown in FIG. 6C is generated with its size and position adjusted differently compared to the first metal pattern PI and the second metal pattern P2.

As such, the layout may be modified to have a condition that satisfies the process margin and the simulation result, and the resulting calculated values may be repeatedly extracted to finally determine a layout that satisfies the target value and output the determined layout.

In FIGS. 6A to 6C, a total of three modified layouts are disclosed, but modifying the layout multiple times to obtain a target value may be within a range of easy design change for one of skill in the art.

According to the layout design method described with reference to FIGS. 3 to 6C, each capacitance value may be extracted based on the initial layout and the layout to which the process margin is applied. Based thereon, data on a relation between each of the layouts and the capacitance value may be ensured. Based on the obtained data, the layout may be further modified. When the layout is further modified, the layout may be modified to satisfy a condition of the second layout considering the process margin, whether the corresponding layout satisfies the design rule may be checked through simulation, and the capacitance value may be checked. This may be performed repeatedly until a layout with the target capacitance value is generated.

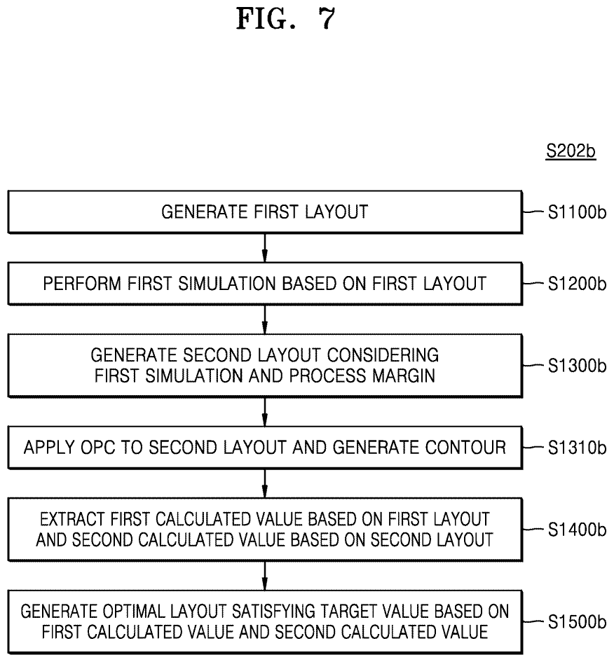

FIG. 7 is a flowchart showing a layout design method according to an example embodiment. In describing the flowchart of FIG. 7, repetition of the flowchart of FIG. 3 will be omitted. Operation S202b shown in FIG. 7 may be an example of operation S202 in FIG. 2.

Referring to operation S1100b, the first layout may be generated. Operation S1100b of FIG. 7 may correspond to operation S1100 of FIG. 3. For example, S1100b of FIG. 7 may be the same as operation S1100 of FIG. 3.

Referring to operation S1200b, the first simulation may be performed based on the first layout. Operation S1200b of FIG. 7 may correspond to operation S1200 of FIG. 3.

Referring to operation S1300b, the second layout may be generated considering the first simulation and the process margin. Operation S1300b of FIG. 7 may correspond to operation S1300 of FIG. 3 and operation S1300a of FIG. 4. For example, S1300b of FIG. 7 may be the same as operation S1300 of FIG. 3 and operation S1300a of FIG. 4.

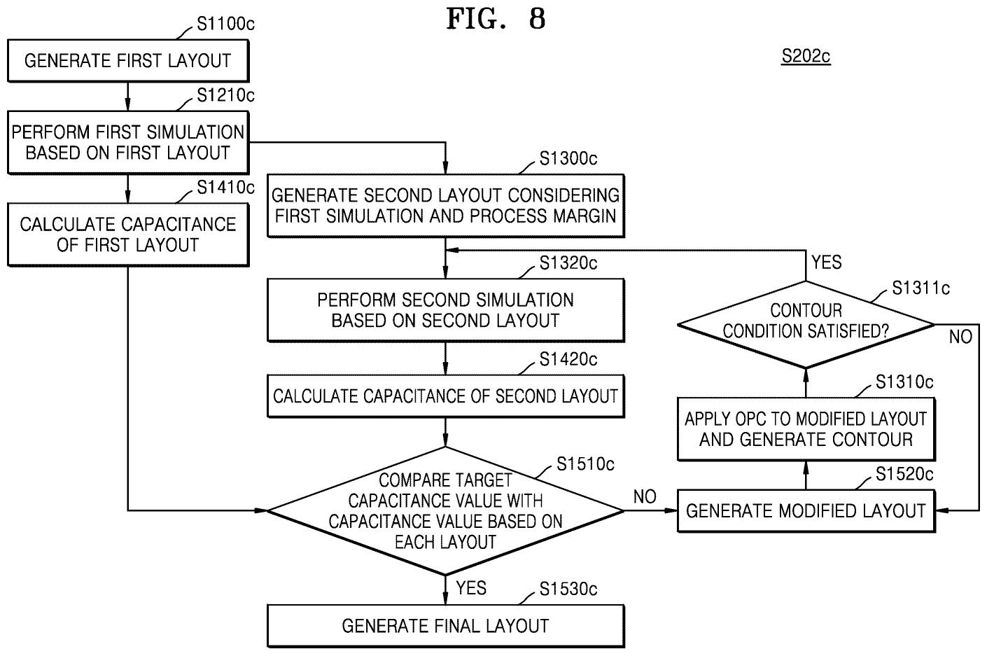

Referring to operation S1310b, OPC may be applied to the second layout and a contour may be generated accordingly. According to the inventive concept, in the design operation, OPC and the corresponding contour may be generated, and additional layout correction may be performed to form a desired target pattern. This will be explained in more detail with reference to FIG. 8 below.

Referring to operation S1400b, the first calculated value based on the first layout and the second calculated value based on the second layout may be extracted. Operation S1400b of FIG. 7 may correspond to operation S1400 of FIG. 3. According to one example, the second calculated value may be calculated based on the contour generated in operation S1310b.

Referring to operation S1500b, an optimal layout that satisfies the target value may be generated based on the first calculated value and the second calculated value. Operation S1500b of FIG. 7 may correspond to operation S1500 of FIG. 3. For example, operation 1500b of FIG. 7 may be the same as operation S1500 of FIG. 3.

A difference between the embodiments of FIG. 7 and FIG. 3 to implement simulation based on a pattern generated in an actual process by performing not only the operation considering the process margin but also OPC and the operation of generating the corresponding contour before capacitance is checked. As such, the layout result with higher accuracy may be generated. The OPC performed in the example of FIG. 7 may be OPC processed in units of unit pixels, and for the layout finally generated according to the flowchart of FIG. 7, OPC may also be performed on a full chip during process operations.

FIG. 8 is a flowchart showing a layout design method according to an example embodiment.

Operation S202c shown in FIG. 8 may be an example of operation S202 in FIG. 3. In describing each operation of FIG. 8, repetition of the above description will be omitted.

In operation S1100c, the first layout may be generated. This may correspond to operation S1100 of FIG. 3. For example, operation S1100c of FIG. 8 may be the same as operation S1100 of FIG. 3.

In operation S1200c, the first simulation may be performed based on the first layout. This may correspond to operation S1200 of FIG. 3. For example, operation S1200c of FIG. 8 may be the same as operation S1200 of FIG. 3.

In operation S1300c, the second layout may be generated considering the first simulation and the process margin. This may correspond to operation S1300 of FIG. 3 and operation S1300a of FIG. 4. For example, operation S1300c of FIG. 8 may be the same as operation S1300 of FIG. 3 and operation S1300a of FIG. 4.

In operation S1320c, the second simulation may be performed based on the second layout. This may correspond to operation S1320a of FIG. 4. For example, operation S1320c of FIG. 8 may be the same as operation S1320a of FIG. 4.

In operation S1410c, capacitance of the first layout may be calculated. In operation S1420c, capacitance of the second layout may be calculated. Operations S1410c and S1420c may correspond to operation S1400 of FIG. 3 and operations S1410a and S1420a of FIG. 4. For example, operations S1410c and S1420c of FIG. 8 may be the same as operation S1400 of FIG. 3 and operations S1410a and S1420a of FIG. 4.

In operation S1510c, the target capacitance value and the capacitance value according to each layout may be compared with each other. This may correspond to operation S1510a of FIG. 4. For example, operation S1510c of FIG. 8 may be the same as operation S1510a of FIG. 4. When an error range of the target capacitance value is different from a capacitance value for each layout, a modified layout may be generated in operation S1520c.

According to the inventive concept, in operation S1310c, OPC may be applied to the modified layout and a contour may be generated. In other words, when the modified layout is generated based on data showing a relation between the primarily obtained metal layout and capacitance, OPC may be applied to the corresponding layout to generate a layout considering the contour result rather than simply generating the layout. In this case, in operation S1311c, it may be determined whether the contour condition is satisfied. Satisfying the contour condition may mean an operation of checking whether a contour shape corresponding to a desired pattern is generated. When the contour condition is not satisfied (No), the layout may be generated again. When the contour condition is satisfied (Yes), simulation may be performed based on the layout (S1320c) and capacitance may be calculated (S1420c). According to another example, when the contour condition is satisfied (Yes), the capacitance may be calculated directly (S1420c) without performing simulation. When the capacitance value that satisfies the target capacitance value is confirmed by repeatedly performing these operations, the final layout may be generated in operation S1530c.

Referring to FIG. 8, in the process of adjusting the capacitance in consideration of the process margin, the layout may be derived more closely to an actual pattern by designing the layout including OPC and the operation of generating the resulting contour.

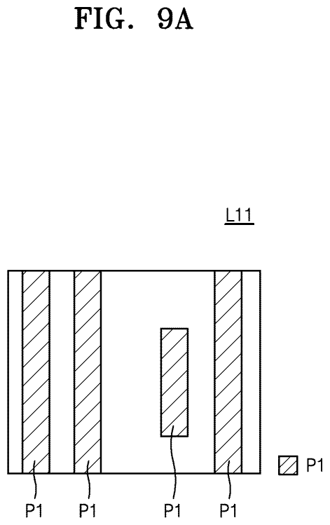

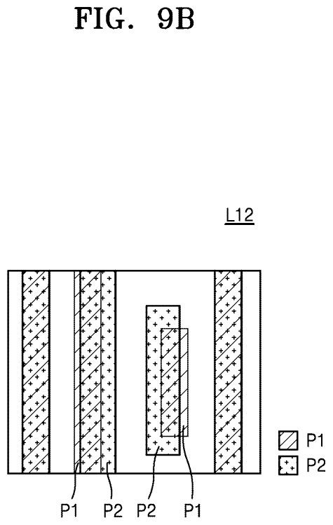

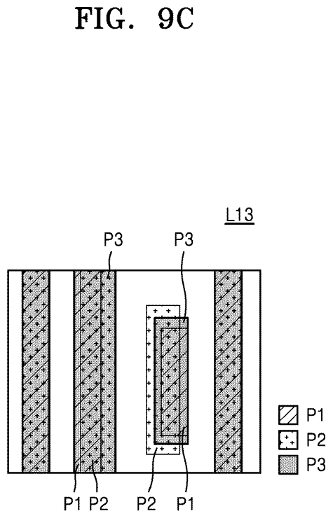

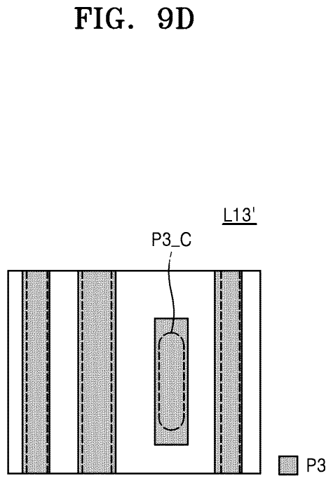

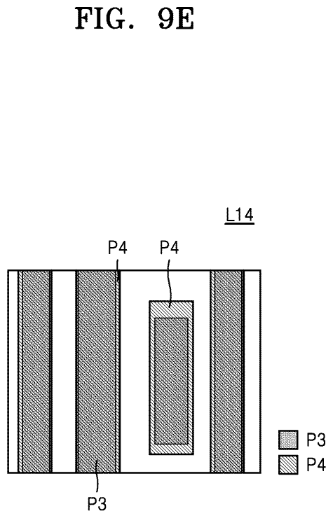

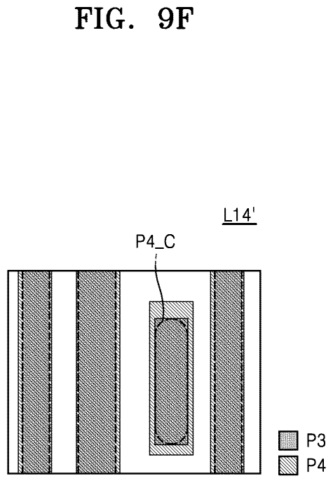

FIGS. 9A to 9F illustrate layouts generated according to an example embodiment.

Referring to FIGS. 9A, 9B, 9C, and 9E, layouts L11, L12, L13, and L14 may include metal patterns P1, P2, P3, and P4, respectively. According to one example, the metal patterns P1, P2, P3, and P4 provided in the layouts L11, L12, L13, and L14 shown in FIGS. 9A, 9B, 9C, and 9E may be a portion of a metal pattern provided in each layout.

The layout L11 according to FIG. 9A may include the first metal pattern P1. The layout L12 according to FIG. 9B may include the second metal pattern P2. The first metal pattern P1 shown in FIG. 9B is shown to easily explain a difference from the second metal pattern P2, and may not be provided in the layout L12. For example, in the layout L12, only the second metal pattern P2 may be provided. The layout L13 according to FIG. 9C may include the third metal pattern P3. The first metal pattern P1 and the second metal pattern P2 shown in FIG. 9C is shown to easily explain a difference from the third metal pattern P3, and may not be provided in the layout L13. For example, in the layout L13, only the third metal pattern P3 may be provided. The layout L14 according to FIG. 9E may include the fourth metal pattern P4. The third metal pattern P3 shown in FIG. 9E is shown to easily explain a difference from the fourth metal pattern P4, and may not be provided in the layout L14. For example, in the layout L14, only the fourth metal pattern P4 may be provided.

According to one example, the layout L11 shown in FIG. 9A may be the first layout corresponding to operation S1100c of FIG. 8. The layout L12 shown in FIG. 9B may be the second layout corresponding to operation S1300c of FIG. 8. The layout L13 shown in FIG. 9C may be a modified layout corresponding to operation S1520c of FIG. 8. A layout L13′ shown in FIG. 9D may be a layout in which OPC is applied to the layout L13 in FIG. 9C to generate a contour P3_C.

The layout L11 shown in FIG. 9A, the layout L12 shown in FIG. 9B, and the layout L13 shown in FIG. 9C overlap the description given in FIGS. 6A, 6B, and 6C, and thus a description thereof will be omitted. For example, the layout L11 of FIG. 9A corresponds to the layout L1 of FIG. 6A, the layout L12 of FIG. 9B corresponds to the layout L2 of FIG. 6B, and the layout L13 of FIG. 9C corresponds to the layout L3 of FIG. 6C. According to one example, the layout L13′ shown in FIG. 9D shows that the contour P3_C is generated based on the layout L13 in FIG. 9C. This may correspond to operation S1310c of FIG. 8. However, as seen from the shape of the contour P3_C in FIG. 9D, the shape of contour P3_C does not correspond to a desired size of the pattern and the shape of contour P3_C is formed in a shape where the edge area is rounded. In this case, it may be determined that a contour condition is not satisfied in operation S1311c of FIG. 8.

The layout L14 of FIG. 9E may be an example in which the layout pattern is modified in consideration of the generated contour P3_C. The pattern P4 provided in the layout L14 of FIG. 9E may be generated to have a larger area than the pattern P3 provided in the layout L13 of FIG. 9C. A layout L14′ shown in FIG. 9F shows that the contour P4_C is generated based on the layout L14 of FIG. 9E. As seen from the shape of the contour P4_C in FIG. 9F, the contour may be generated to correspond to a desired size of the pattern, and in this case, it may be determined that the contour condition is satisfied in operation S1311c of FIG. 8. In other words, a layout with more pattern accuracy may be designed by applying OPC as such and generating the contour based thereon to additionally modify the layout.

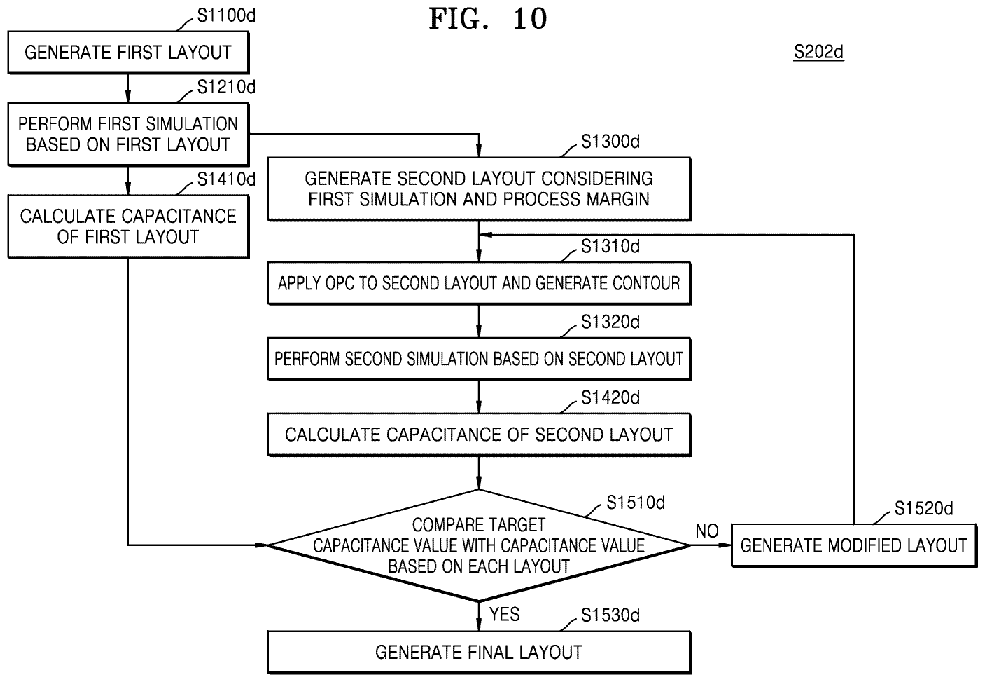

FIG. 10 is a flowchart showing a layout design method generated according to an embodiment.

Operation S202d shown in FIG. 10 may be an example of operation S202 in FIG. 3. In describing each operation of FIG. 10, repetition of the above description will be omitted.

In operation S1100d, the first layout may be generated. In operation S1210d, the first simulation may be performed based on the first layout. In operation S1300d, the second layout may be generated considering the first simulation and the process margin. The above-described operations may respectively correspond to operations S1100c, S1210c, and S1300c described in FIG. 8. For example, operations S1100d, S1210d, and S1300d of FIG. 10 may be the same as operations S1100c, S1210c, and S1300c, respectively, of FIG. 8.

Referring to operation S1310d, OPC may be applied to the second layout and a contour may be generated based thereon. According to one example, OPC may be directly applied to the second layout considering the process margin and a contour may be generated accordingly. A difference between the embodiments of FIG. 10 and FIG. 8 is that the operation of applying the OPC and the operation of generating the contour are applied immediately after generating the second layout.

In operation S1320d, the second simulation may be performed based on the second layout. In operation S1410d, capacitance of the first layout may be calculated. In operation S1420d, capacitance of the second layout may be calculated. The corresponding operations may respectively correspond to operations S1320c, S1410c, and S1420c of FIG. 8. For example, operations S1320d, S1410d, and S1420d of FIG. 10 may be the same as operations S1320c, S1410c, and S1420c, respectively, of FIG. 8.

In operation S1510d, the target capacitance value and the capacitance value according to each layout may be compared with each other. The corresponding operation may correspond to operation S1510c of FIG. 8. In operation S1520d, the modified layout may be generated. This may correspond to operation S1520c of FIG. 8. In operation S1530d, the final layout may be generated. This may correspond to operation S1530c of FIG. 8. For example, operations S1510d, S1520d, and S1530d of FIG. 10 may be the same as operations S1510c, S1520c, and S1530c, respectively, of FIG. 8.

According to the inventive concept, to prevent the metal layout for matching the capacitance for the purpose of targeting the conversion gain from being arbitrarily changed and prevent the consistency of conversion gain from being disturbed, the process margin may be considered in a preliminary layout design operation, and according to an embodiment, a layout with higher consistency may be generated through design in consideration of OPC and the resulting contour.

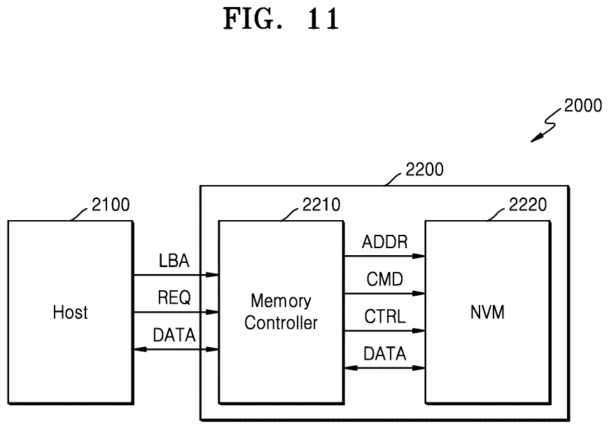

FIG. 11 is a block diagram showing a memory system to which a layout design method is applied according to an example embodiment.

Referring to FIG. 11, a memory system 2000 may include a host 2100 and a memory device 2200. The memory device 2200 may include a memory controller 2210 and a non-volatile memory 2220, which are designed based on a layout design method according to an embodiment. The host 2100 and the memory device 2200 may be electrically connected to each other. The host 2100 may provide a logical block address (LBA) and a request signal (REQ) to the memory device 2200, and the host 2100 and the memory device 2200 may exchange data DATA. For example, the host 2100 may be connected to the memory controller 2210.

The host 2100 may include, for example, a personal computer (PC), a laptop, a mobile phone, a smart phone, or a tablet PC.

The memory device 2200 may include the memory controller 2210 and the non-volatile memory 2220. The memory device 2200 may be integrated into one semiconductor device. In an integration process of the memory device 2200, when each of the various components provided in the memory device 2200 is designed, the layout design method according to an embodiment may be used. For example, the memory device 2200 may include an embedded universal flash storage (UFS) memory device, an embedded multi-media card (eMMC), solid state drive (SSD), removable UFS memory card, compact flash (CF), secure digital (SD), micro secure digital (micro-SD), mini secure digital (mini-SD), extreme digital (xD), or memory stick, to which the layout design method according to an embodiment is applied.

The non-volatile memory 2220 may also include NAND flash memory or NOR flash memory to which the layout design method according to an embodiment is applied, or a resistive memory such as phase-change RAM (PRAM), magneto resistive RAM (MRAM), ferroelectric RAM (FeRAM), and resistive RAM (RRAM).

The memory controller 2210 may be connected to the non-volatile memory 2220 and may control the non-volatile memory 2220. For example, the memory controller 2210 may provide an address ADDR, command CMD, and control signal CTRL to the non-volatile memory 2220 in response to a logical block address LBA and a request signal REQ that are received from the host 2100. That is, the memory controller 2210 may provide signals to the non-volatile memory 2220 and control to write data to the non-volatile memory 2220 or read data from the non-volatile memory 2220. The memory controller 2210 and the non-volatile memory 2220 may exchange the data DATA.

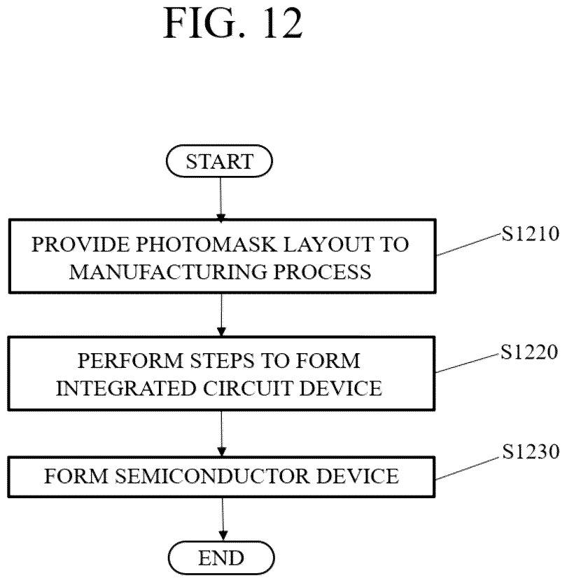

FIG. 12 is flowchart illustrates a method of manufacturing semiconductor device using a photomask optimized according to example embodiments. The operations of FIG. 12 may correspond to operation S205 of FIG. 2.

First, in operation S1210, a photomask formed by the methods disclosed herein may be provided to a location where semiconductor manufacturing is performed. For example, the photomask may be moved via a loading device (e.g., using an electro-mechanical device connected to a holder such as a hand-gripper, in a manner that allows the mask to be picked up and/or moved) into equipment that uses the photomask for photolithography.

Next, in operation S1220, the photomask may be used to perform a step in forming an integrated circuit device such as a semiconductor wafer. For example, the photomask may be placed in a chamber where a semiconductor wafer is disposed, and may be used for a photolithography process to form a pattern on the semiconductor wafer. Subsequently, in operation S1230, additional steps may be performed on the wafer, for example to form a semiconductor device. For example, additional layers may be deposited on the wafer to form semiconductor chips, the semiconductor chips may then be singulated, packaged on a package substrate, and encapsulated by an encapsulant to form a semiconductor device.

The above steps may be controlled by a control system including one or more computers and one or more electro-mechanical devices for moving a travelling part within a transferring apparatus. Also, though the above steps are described in a particular order, they need not occur in that order necessarily.

As above, embodiments have been disclosed in the drawings and specification. Although embodiments have been described in this specification using certain terms, this is merely used for the purpose of explaining the technical idea of the inventive concept and is not used to limit the meaning or scope of the inventive concept as set forth in the claims. Therefore, one of skill in the art will understand that various modifications and other equivalent embodiments are possible therefrom. Therefore, the true technical scope of the inventive concept should be determined by the technical spirit of the attached claims.

While the inventive concept has been particularly shown and described with reference to embodiments thereof, it will be understood that various changes in form and details may be made therein without departing from the spirit and scope of the following claims.

What is claimed is:

1. A layout design method comprising:
generating a first layout of an integrated circuit;
performing first simulation on the first layout;
generating a second layout considering the first simulation and a process margin;
extracting a first calculated value based on the first layout and a second calculated value based on the second layout; and
generating a final layout that satisfies a target value based on the first calculated value and the second calculated value,
wherein the first calculated value and the second calculated value include values calculated by circuit structures corresponding to the first layout and the second layout, respectively.

2. The layout design method of claim 1, wherein the extracting of the first calculated value and the second calculated value includes calculating a capacitance value at a conversion gain of a pixel circuit corresponding to each of the first layout and the second layout.

3. The layout design method of claim 1, wherein the generating of the second layout considering the process margin includes generating a second layout to which a table driven layer operation (TDLO) is applied.

4. The layout design method of claim 1, wherein the generating of the final layout that satisfies the target value based on the first calculated value and the second calculated value includes comparing the first calculated value and the second calculated value with the target value.

5. The layout design method of claim 4, further comprising, when the first calculated value or the second calculated value is within an error range of the target value, outputting the second layout as the final layout.

6. The layout design method of claim 4, wherein the generating of the final layout that satisfies the target value based on the first calculated value and the second calculated value includes, when the first calculated value or the second calculated value is outside an error range of the target value, modifying a layout to have a calculated value in the error range of the target value.

7. The layout design method of claim 6, wherein the modifying of the layout includes modifying the layout in a range that satisfies both design rules and a condition of the process margin.

8. The layout design method of claim 1, wherein the performing of the first simulation includes determining whether the first layout satisfies at least one of design rule check (DRC), electrical rule check (ERC), and layout vs schematic (LVS) conditions.

9. A layout design method comprising:
generating a first layout of an integrated circuit;
performing first simulation on the first layout;
generating a second layout considering the first simulation and a process margin;
extracting a first calculated value based on the first layout and a second calculated value based on the second layout; and
generating a final layout that satisfies a target value based on the first calculated value and the second calculated value,
wherein the generating of the final layout includes performing optical proximity correction and generating a contour based on the optical proximity correction to modify a layout, and
wherein the first calculated value and the second calculated value are values calculated by circuit structures corresponding to the first layout and the second layout, respectively.

10. The layout design method of claim 9, wherein the generating of the final layout includes performing the optical proximity correction on the second layout and generating a contour based on the optical proximity correction.

11. The layout design method of claim 9, wherein the generating of the final layout includes:
generating a third layout having a value closer to a target value based on the first calculated value and the second calculated value; and
performing the optical proximity correction on the third layout and generating a contour based on the optical proximity correction.

12. The layout design method of claim 11, further comprising checking whether a shape of the generated contour corresponds to a desired pattern shape.

13. The layout design method of claim 12, further comprising, when a shape of the generated contour corresponds to the desired pattern shape, extracting a calculated value based on the third layout.

14. The layout design method of claim 12, further comprising, when a shape of the generated contour does not correspond to the desired pattern shape, additionally modifying the third layout.

15. The layout design method of claim 9, wherein the extracting of the first calculated value and the second calculated value includes calculating a capacitance value at a conversion gain of a pixel circuit corresponding to each of the first layout and the second layout.

16. The layout design method of claim 9, wherein the generating of the second layout considering the process margin includes generating a second layout to which a table driven layer operation (TDLO) is applied.

17. The layout design method of claim 9, wherein the performing of the first simulation includes determining whether the first layout satisfies at least one of design rule check (DRC), electrical rule check (ERC), and layout vs schematic (LVS) conditions.

18. A method of manufacturing a semiconductor device, the method comprising:
performing design of the semiconductor device; and
manufacturing the semiconductor device based on the design,
wherein the performing of the design of the semiconductor device includes:
performing high level design; and
performing layout design based on the high level design,
wherein the manufacturing of the semiconductor device includes:
performing optical proximity correction based on the designed layout; and
manufacturing a mask based on a result of the optical proximity correction,
wherein the performing of the layout design includes:
generating a first layout of an integrated circuit;
performing simulation based on the first layout;
generating a second layout considering the simulation and a process margin;
extracting calculated values based on the first layout and the second layout, respectively; and
modifying the second layout to satisfy a target value based on the calculated value, and
wherein the calculated values include a value calculated by circuit structures corresponding to the first layout and the second layout, respectively.

19. The method of claim 18, wherein the modifying of the second layout includes performing optical proximity correction on the second layout and generating a contour based on the optical proximity correction.

20. The method of claim 18, wherein the extracting of the calculated values based on the first layout and the second layout, respectively includes calculating a capacitance value at a conversion gain of a pixel circuit corresponding to each of the first layout and the second layout.
